(19) United States
(12) Patent Application Publication
(10) Pub. No.: US 2010/0234986 A1
(43) Pub. Date: Sep. 16, 2010

(54) METHOD AND SYSTEMS FOR COLLECTING INVENTORY AND MARKETING DATA, PROVIDING DATA AND VIDEO SERVICES

(75) Inventors: Ian Clopton, Oakland, CA (US); John R. Riera, San Francisco, CA (US); Laura Riera, San Francisco, CA (US); Lorraine Legg, San Francisco, CA (US)

Correspondence Address: QUINE INTELLECTUAL PROPERTY LAW GROUP, P.C., P O BOX 458, ALAMEDA, CA, 94501, US

(73) Assignee: Qwik-Count LLC, c/o Qwik-Count Management, Inc., San Francisco, CA (US)

(21) Appl. No.: 12/686,376

(22) Filed: Jan. 12, 2010

Related U.S. Application Data
(60) Provisional application No. 61/144,120, filed on Jan. 12, 2009.

(51) Int. Cl. G06F 7/00; G06Q 10/00; G06F 15/16; H04N 7/18

(52) U.S. Cl. 700/236; 700/232; 709/201; 348/150

(57) ABSTRACT

Methods and systems for providing inventory and/or marketing services using distributed devices and a network or communications medium such as via the Internet. In specific embodiments, a thin client logic system is installed at multiple item dispensers and communicates inventory and/or marketing data to a server system. The server system provides a central data location from which a supplier can provide inventory and/or marketing data services potentially to many different customers.

### CROSS REFERENCE TO RELATED APPLICATIONS

This application claims priority from provisional patent application 61/144,120 filed 12 Jan. 2009 and incorporated herein by reference. This application claims priority from U.S. patent application Ser. No. 12/685,675 filed 11 Jan. 2010 and incorporated herein by reference.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### FIELD OF THE INVENTION

The present invention relates to distributed automated inventory control systems. More particularly, it relates to computer systems and methods that are involved with motion detection and/or collection of inventory and/or marketing data and providing related services at distributed sites that provide inventory dispensary, such as vending machines.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

### SUMMARY

According to specific embodiments, the present invention is involved with methods and/or systems and/or devices that can be used together or independently to provide data services related to distributed inventory control and/or marketing data collection. In other embodiments, the invention involves new methods of automated motion detection.

The present invention provides an improved system and/or method for inventory information collection and related tasks from a plurality of distributed automated item dispensing machines (herein after, vending machine, though throughout this to discussion the term “vending machine” encompasses any kind of automated dispensing machine.)

The present invention includes a client control module (at times herein referred to as a “thin-client” or Qwik-Count® module) that is installed at the location of a vending machine (preferably inside the housing of the vending machine) and is programmed to perform the functions described herein. Such a client control module can be a small generally purpose computer or a custom built information processing module and include a logic processor, working and long term memory storage, and communication interfaces as will be understood in the art. The client control module interfaces locally with at least one inventory data capture device also installed at (preferably inside) of a vending machine. The inventory data capture device (e.g. a digital cameras) operates substantially or entirely independently of the vending machine and allows the client module to determine the status of inventory at the vending machine substantially or entirely independently of any native control system or circuitry of the machine. The client module also has a communications interface allowing it to exchange information with a server system (one or many distant computer systems) and thereby inform users of the inventory control system of various status information at the vending machine as described herein.

With the present invention, because the client module, inventory capture device, and server are substantially or completely independent of the vending machine control systems, the invention can be deployed over a variety of different vending machines without regard to various, often complicated, native data interfaces provided at the vending machines. With inventory image capture and analysis as described herein, a user of the system can manage a variety of vending machines at widely distributed locations with little or no modification to the installed vending machines.

With this basic system in place, a number of additional and optional services can be provided at vending machines using a client module of the present system.

A local data interface (either wired, such as through a USB connection) or wireless (such as using WiFi or wireless USB or blue tooth) can be provided to allow a stocker (or driver or servicer) locally present at a vending machine to read inventory information from the machine and to input (such as through a hand-scanner (bar-code or RFID) information about new product being placed in the vending machine.

A purchaser camera, which may be a separate camera or integrated with the inventory camera), can capture images or video of customers at the vending machine for security purposes or to track customer behavior as described below.

A display (either passive or a touch-screen) that is logically independent of the vending machine, can be mounted to be visible to a customer and used by the client module to provide promotional, advertising, or informational data (such as nutritional information).

A credit-card or other electronic payment input device that is logically independent of the vending machine, can be mounted to be accessible to a customer and used by the client module to accept and process payment information. This allows vending machines without credit card capability to be credit card enabled. For this optional function, generally so form of limited communication to the vending machine to instruct the machine to vend an item once a payment has been verified is used.

The client modules, once installed in a vending machine, can also include or be connected to a wireless router to provide local wireless IP service and to other data devices, such as an external area surveillance camera.

With a system according to specific embodiments of the invention, many different vending machines, from many different manufacturers, can be collected into a single inventory and management group without the need for difficult and/or expensive modifications to the vending machines themselves and without the need for integrating different data collection functions and data formats that may be available from various vending machines internal logic processing.

Furthermore, with a system according to specific embodiments of the invention, many different vending machines, from many different manufacturers, can be used as a physical and physically secured service point for providing a range of different data and video services, including data collection, data verification, surveillance, data display, advertising, communication, etc.

Thus, in further embodiments, the present invention may be understood in the context of gathering and supply marketing and inventory data over a communication media. An important application for the present invention, and an independent embodiment, is in the field of providing such data and services over the Internet, optionally using Internet media protocols and formats, such as HTTP, RTTP, XML, HTML, dHTML, VRML, as well as image, audio, or video formats etc. However, using the teachings provided herein, it will be understood by those of skill in the art that the methods and apparatus of the present invention could be advantageously used in other related situations where users access content over a communication channel, such as modem access systems, institution network systems, wireless systems, etc.

### Software Implementations

Various embodiments of the present invention provide methods and/or systems for image analysis, motion detection, and data analysis and collection that can be implemented on a general purpose or special purpose information handling appliance using a suitable programming language such as Java, C++, Cobol, C, Pascal, Fortran, PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

### Other Features & Benefits

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and equivalents.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, etc. Furthermore, in some aspects, the present invention is described in terms of client/server systems. A number of computing systems and computing architectures are described in the art as client/server art. For the purposes of this description, client/server should be understood to include any architecture or configuration wherein an element acting as a client accesses a remote and/or separate program or device that is providing the desired service (e.g., a server).

All references, publications, patents, and patent applications cited herein are hereby incorporated by reference in their entirety for all purposes.

### BRIEF DESCRIPTION OF THE DRAWINGS

FIG. 1 is a block diagram illustrating a thin client system according to specific embodiments of the present invention.

FIG. 2 is a block diagram illustrating another example thin client system (or vending machine module) according to specific embodiments of the present invention.

FIG. 3 is a block diagram illustrating an example vending machine with a client module, inventory capture devices, and other components according to specific embodiments of the present invention.

FIG. 4 is a flow chart illustrating providing vending machine inventory management according to specific embodiments of the present invention.

FIG. 5 is a flow chart illustrating providing additional vending machine services according to specific embodiments of the present invention.

FIG. 6 is a flow chart illustrating providing vending item display services according to specific embodiments of the present invention.

FIG. 7 is a diagram (on 3 sheets) showing work flow chart illustrating inventory services according to specific embodiments of the present invention.

FIG. 8 is a block diagram showing a representative example logic device in which various aspects of the present invention may be embodied.

### DESCRIPTION OF SPECIFIC EMBODIMENTS

Before describing the present invention in detail, it is to be understood that this invention is not limited to particular compositions or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

Unless defined otherwise, technical and scientific terms used herein have meanings as commonly understood by one of ordinary skill in the art to which the invention pertains. Although any methods and materials similar or equivalent to those described herein can be used in practice or for testing of the present invention, the preferred materials and methods are described herein.

### Overview

Many computerized systems exist for inventory control. United States Patent Application 20080001747, for example, discusses a security system for inventory that automatically detects removal of inventory items from an area protected with security sensors and then provides a time window for a person removing the item to scan an identifying code of the item, such as its bar code or radio-frequency identification (“RFID”) tag, with a device such as a portable shopping assistant device.

It is known that various electronic vending or dispensing machines may contain logic processor based control systems, sometimes referred to as vending machine controllers (VLC). The European Vending Association's Data Transfer Standard (“EVA-DTS”) and the National Automatic Merchandising Association's (NAMA) Multi-Drop Bus/Internal Communications Protocol (MDB/ICP or MDB) are used in some systems for handling data associated with vending machines. (see, www(.)vending(.)org/technical(/)MDB_{—}3.0.pdf, also see, e.g., SYSTEM, METHOD AND APPARATUS FOR IDENTIFYING AND CORRECTING DATA INTEGRITY PROBLEMS ASSOCIATED WITH REMOTELY LOCATED EQUIPMENT (Inventors: Bryan W. Godwin), U.S. Published Application 20080243566, application Ser. No. 11/691,789, filed Mar. 27, 2007 AND U.S. 20090013028.)

Many vending systems are described that use a CPU or other processor integrated with a vending machine to count a number of different items and transmit data to a remote location either for scheduling service calls or for inventory control. U.S. Pat. No. 6,980,887, for example, (APPARATUS AND METHOD FOR IMPROVED VENDING MACHINE INVENTORY MAINTENANCE) discusses a system of one or more vending machines with unique identifiers and electronics for collecting and transmitting information concerning goods dispensed and other status to a remote location to provide a service schedule. The documents referenced therein discuss many further different systems that generally require a vending machine to have an integrated CPU or other logic processing device that can collect vending information (such as by detecting button selections of users or detecting control signals sent to vending hardware).

U.S. Pat. No. 6,230,150 (Vending machine evaluation network) discusses adjusting a price or other sales information associated with a product at one or more initial vending machines, before automatically and progressively expanding the new price or other sales information to additional vending machines, upon verification of a successful change. Successful test results are thus automatically propagated to additional vending machines for further testing in the market. The sales information that can be tested includes price, product placement instructions, new advertising or promotional instructions, and packaging instructions for the sale of a group of products at a single price.

Other strategies for using various logic processing systems with vending machines are discussed in the following documents:

| | | | |
|---|---|---|---|
| 4412292 | System for the remote monitoring of vending | October, 1983 | Sedam et al. |
| | machines | | |
| 4498570 | Multiple purchase discount module for a single | February, 1985 | King et al. |
| | price vending machine | | |
| 4593361 | Vending machine control circuit | June, 1986 | Otten |
| 4654800 | Control and monitoring apparatus for vending | March, 1987 | Hayashi et |
| | machines | | al. |
| 4679150 | Automatic vending machine with discount | July, 1987 | Hayashi et |
| | function | | al. |
| 4766548 | Telelink monitoring and reporting system | August, 1988 | Cedrone et |
| | | | al. |
| 4981027 | Three position lock mechanism for a vending | January, 1991 | Friedman et |
| | machine | | al. |
| 5091713 | Inventory, cash, security, and maintenance | February, 1992 | Horne et al. |
| | control apparatus and method for a plurality of | | |
| | remote vending machines | | |
| 5159560 | Automated merchandise dispensing and retrieval | October, 1992 | Newell et al. |
| | system | | |
| 5257179 | Audit and pricing system for coin-operated | October, 1993 | DeMar |
| | games | | |
| 5339250 | Interactive network for remotely controlled hotel | August, 1994 | Durbin |
| | vending systems | | |
| 5367452 | Mobile merchandising business management | November, 1994 | Gallery et al. |
| | system which provides comprehensive support | | |
| | services for transportable business operations | | |
| 5701252 | Distribution network system for products and | December, 1997 | Facchin et |
| | information | | al. |
| 5930771 | Inventory control and remote monitoring | July, 1999 | Stapp |
| | apparatus and method for coin-operable vending | | |
| | machines | | |
| 5988346 | Method and apparatus for establishing and | November, 1999 | Tedesco et |
| | managing vending machine subscriptions | | al. |
| 5997928 | Method and apparatus for verifying contents of | December, 1999 | Kaish et al. |
| | vending systems | | |
| 6012834 | Apparatus and method for automatic self- | January, 2000 | Dueck et al. |
| | adapting control of sales and adjustment of prices | | |
| | to market movements in an automatic vending | | |
| | machine | | |
| 6021394 | Sales management method in automatic vending | February, 2000 | Takahashi |
| | machine | | |

Characteristic of many of these systems is that the systems require interfacing with the mechanics and/or electronics of the vending machines. Some systems also require cumbersome data collection. The Easitrax™ Data Port, for example, requires route drivers to collect transaction data from vending machines and transfer it into vending management software, for example using a USB port or other local connection. (Additional background information is available at www(.)easitrax(.)com). While many CPU enabled machines contain a large amount of information, such as product sales, coin drops, bill insertions and more, the nature of vending machines with incorporated CPUs can make the data difficult to access.

### Example Vending System

The present invention provides an improved vending machine (or other item dispensing machine) inventory and control system that has data collection and logic processing functions, such as, but not limited to display functions, motion detection functions, image capture functions. According to specific embodiments of the invention, these functions are mostly or entirely independent of the vending machine's native control mechanisms (whether digital or analog or mechanical) and thus can be installed on many different types of vending machines without need for a substantial digital data interface between existing vending machines and the components of the invention. In specific implementations the invention may be referred to as the QwikCount® Vending Machine and Server System, which in specific implementations may be referred to as the Qwik-Count® Package.

In specific embodiments, the invention accomplishes data gathering functions using one or more imaging devices that can be mounted near, on, or inside a vending machine. Imaging devices can include such things as digital cameras that detect visible and/or infrared and/or ultraviolet light.

The invention further involves a local logic processor (such as a CPU and associated components) and communications equipment (such as a wired or wireless internet connection, a mobile phone connection, a telephone modem connection, or any other convenient communications means) for performing one or more data and video services, such as transmitting various locally collected information to a server, receiving data from a server, or other services as described herein. In specific embodiments, collected data and video can be understood to be transmitted to a central server service, which may reside on one or many computer systems.

With a system according to specific embodiments of the invention, many different vending machines, from many different manufacturers, can be collected into a single inventory and management group without the need for difficult and/or expensive modifications to the vending machines themselves and without the need for integrating different data collection functions and data formats that may be available from various vending machines internal logic processing.

Furthermore, with a system according to specific embodiments of the invention, many different vending machines, from many different manufacturers, can be used as a physical and physically secured service point for providing a range of different data and video services, including data collection, data verification, surveillance, data display, advertising, communication, etc.

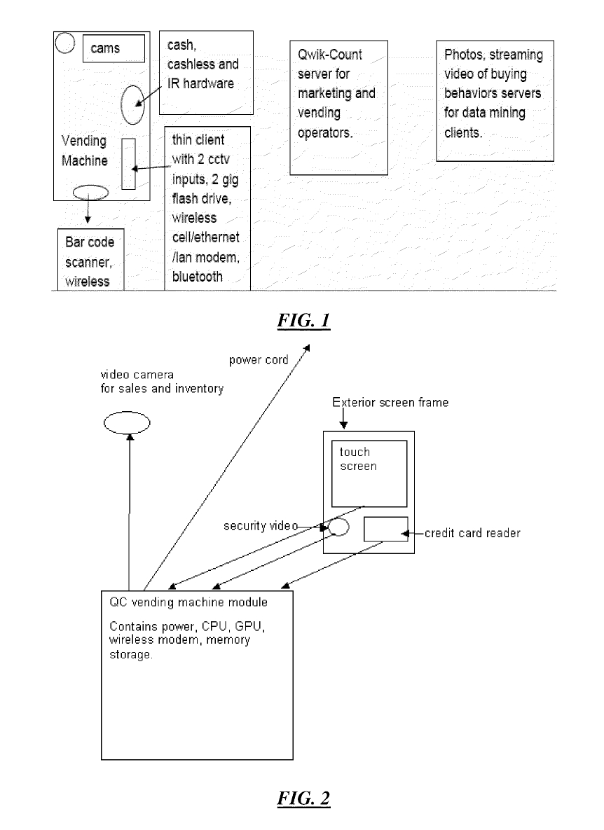

FIG. 1 is a block diagram illustrating a thin client system according to specific embodiments of the present invention. In this example system, a thin client 100 contains hardware and software as described herein and resides on or inside of a vending machine 110. Thin client 100 can include or provide interfaces to a bar code scanner 112 and cash or cashless transaction hardware 105. The thin client communicates over a communication channel 120 with a server 150. Server 150, as described herein can make various data 160 available to users, such as photos, streaming video, etc.

FIG. 2 is a block diagram illustrating another example thin client system (or vending machine module) according to specific embodiments of the present invention. Again, a “thin client” or vending machine module 100 is shown. As discussed herein, such a client can comprise a netbook, laptop, or other small foot-print computer system, including a custom built computer system. According to specific embodiments of the invention, this computer system is preferably installed within a vending machine housing. This computing system includes one or more interfaces, such as to a touch screen 170, a credit card reader 180, a security video capture device 175, and an inventory and sales video capture device 190. A power connector 195 powers the vending machine module and can be separate from or integrated into the vending machine power supply.

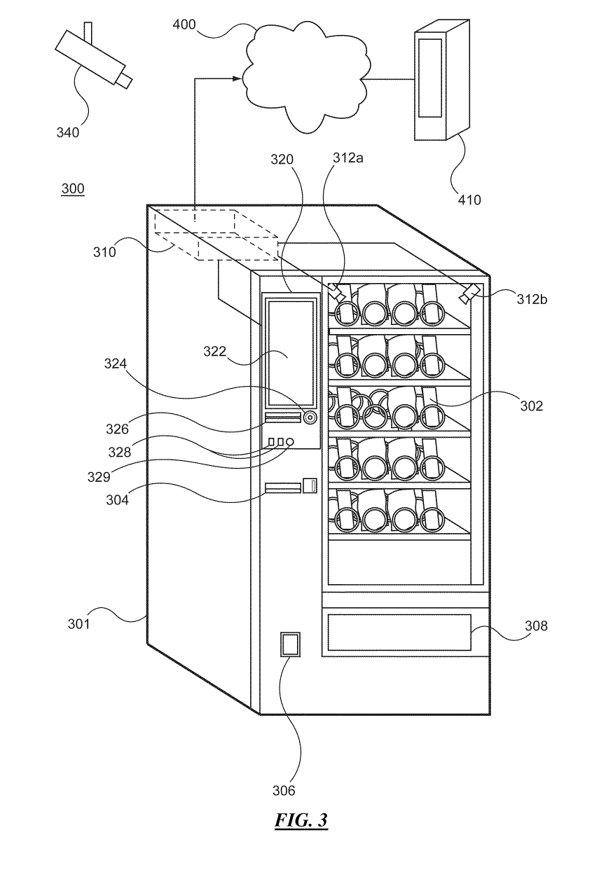

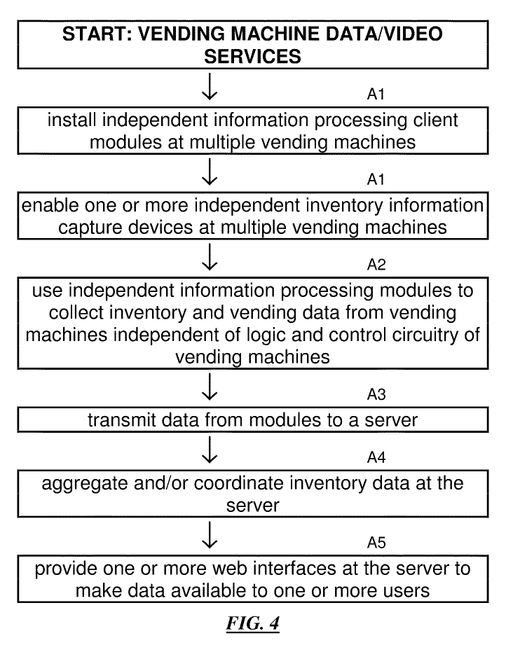

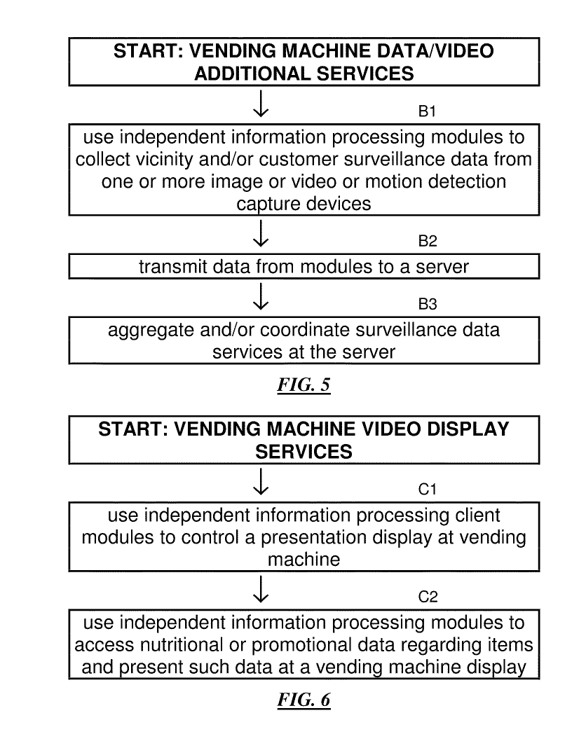

FIG. 3 is a block diagram illustrating an example vending machine with a client module, inventory capture devices, and other components according to specific embodiments of the present invention. FIG. 3 shows as an example a legacy vending machine 300 having a housing 301, items 302, bill and/or coin payment devices 304 and a drop slot retrieval 308. This particular configuration of a vending machine is an example only, and any type of vending machine, including those in which customers do not see any of the products before vending, can be used in a system of the invention. According to the invention, a client module 310 is placed inside of housing 301. As discussed else where, this module can be a general purpose computer system programmed to perform the functions as described herein, as will be understood in the art, or a custom logic processing module. This module is generally not visible to vending machine customers. Inventory capture cameras 312a and 312b and logically connected to 301 (via a wired or wireless connection) and positioned to have a view of the available inventory of items. This cameras can be positioned anywhere convenient inside or outside of the vending machine housing 301 and may be positioned in such a way that they may or may not be visible to a customer. Module 301 has a wired or wireless connection to a communications network 400 (e.g., the Internet) and through that exchanges data with a remote server system 410 (which may be one or many computer systems). With just these components, a system according to specific embodiments of the invention can provide various inventory management tasks as described herein.

Additional components include one or more interfaces for allow a stocker at the machine to communicate with module 310, such as USB ports 328, IR or blue tooth receiver 329. A credit card or other electronic payment reader 326 allows module 310 to process electronic payments and a customer camera 324 allows image capture of the customer. A display 322 (passive or touch-screen) allows module 310 to provide various displays to a customer as described herein. Each of these components can be various placed according to specific embodiments of the invention, and some may not be externally visible. In the illustrated example, a number of these components are collected into an interface panel 320, which is mounted to or in vending machine housing 301 in such a way as to allow the necessary customer interaction.

One or more additional devices, such as external surveillance camera 340, may be installed at the vending machine site and communicate with a module 310 and thereby with any necessary network resource, such as server 410.

Thus, according to specific embodiments of the invention, the invention involves a hardware and software system that resides at the location of a vending machine (e.g., on or inside a vending machine casing) (generally referred to as the client side part of the system) and on a server system. A vending machine portion of such a system performs one or more data tasks as described herein, such as gathering sales and inventory data on a individual vending machine by the use of a visible light or infrared camera and transmitting such data to Qwik-Count's server system. The server system processes the information and transmits reports and other data that contains data of interest, such as sales (money) and/or necessary restocking inventory by machine and by route. This information can be delivered in a variety of known or proprietary formats electronically to vending operator clients, using available wireless or wired communications networks (including an iPhone/smartphone, telephone link, internet link, private network ling, etc.).

A client system at a vending machine may also be used to display data to a user that is supplemental to, different from, or an extension of data that is available from the vending machine itself. Such data can include nutritional information about various products, advertisements for vending machine products or other products or services, etc.

In specific embodiments, other reports are available for download from a secure vendors website. Reports can be delivered in any desired format and/or via a simple web application. Sales, inventory and other types of data can be downloaded from central servers and easily imported into a wide variety of commonly used business applications.

According to specific embodiments of the invention, a novel vended item motion detection system as described herein is used on the vending machines to determine product sales and category management and to confirm a successful vend. While the novel motion detection described herein is one embodiment, any type of motion detection system can be used.

According to specific embodiments of the invention, a security camera in or on or near a vending or dispensing machine can also take a time-stamped photo/video of a buyer/user or servicer of the machine.

In specific embodiments, images of buyers are associated with the corresponding database entry that tracks the specifics of their purchase including: Methods of payment, what was purchased, date, time and location.

In further embodiments of the invention, this dispensing/purchase history database combined with the photo/video of an recipient can be made available to marketing companies and other entities of interest, for example via a subscription service.

The images from a security camera can be used as a surveillance tool for a variety of issues that confront vending operators.

Using the security camera's video of consumers during vend purchases in further embodiments can track eye movement and facial expression to determine effective product placement. Reports on product placement assessments can be sold on a subscription basis to manufacturers and advertising firms for data gathering, mining and forecasting purposes. In addition, the video of consumers during vend transactions can be supplied to the aforementioned industries through a subscription so they may apply their own analysis procedures to determine product placement, mood, etc.

In particular embodiments, the invention involves a vending or dispensing machine thin-client system having a video interface, storage, long-range communications interface, and optionally near-range communications interface. An example system includes a logic processor (e.g., a CPU), a graphics processing unit (e.g. GPU), appropriate memory, and data transmission devices such as a touch screen and a credit card reader. In specific example embodiments, a touch screen provides sales price, nutritional information, branding and interactive advertising. An example system also generally includes a memory for storing data and logic instructions, one or more video inputs, one or more long distance communication interfaces (e.g., wireless cell/Ethernet/LAN modem), a near-distance communication interface (e.g., Blue tooth and/or RFID antennas), and one or more visible or non-visible light capture devices (e.g., visible or infrared cameras.)

Other components may also be used in association with a thin client according to specific embodiments of the invention. For example, a portable scanner can be used by a dispensing machine servicer to scan items placed into a dispensing machine. In specific embodiments, inventory and a screen display of the nutritional information, use bar code information that is scanned either at the machine or pre-kitted (e.g., at the warehouse all merchanside needed for each specific machine is packed in a specific box for that specific machine.) In further embodiments, a portable bar code scanner of the invention can also scan identifiers placed on each separate dispensing machine (e.g., easily placed bar-code tags or RFID tags), and optionally can further scan identifiers associated with each dispensing location of a particular machine (e.g., row and column of a typical vending machine.) In further embodiments, a portable bar code scanner can include a display or other indicia through which a thin-client can communicate with a servicer data such as inventory present in a vending machine, perishable inventory that may need to be replaced, instances of failed vending operations, totals of money that should be present in a vending machine, etc.) In further embodiments, a portable scanner of the invention may include a bar-code reader or RFID reader for collecting identification information from one or more items stocked into a dispensing machine. In further embodiments, a portable scanner of the invention may include a keyboard or other input device allowing a service to enter additional data that may be received and stored by said thin client using said local interface.

Further components may also be used in association with a thin client according to specific embodiments of the invention. For example, a display screen or touch screen can be positioned to be viewable to a customer and/or to a casual passer-by. Because of the independent yet integrated nature of the thin client, the display screen can be easily configured using known technology to display such information to a consumer as nutrition or further product information, advertisements, payment instructions, etc. The display screen can also be used to display important information to a servicer, such as messages for a dispatch center, various inventory information (the presence of expired product, for example), or servicer information such as the amount of cash that should be collected and/or change deposited in a particular dispenser.

In a further embodiment, a credit-card or other payment processing components may also be used in association with a thin client according to specific embodiments of the invention. In such a situation, the thin client can more easily interface with external payment authorization services, than is possible using most proprietary VLC dispensers.

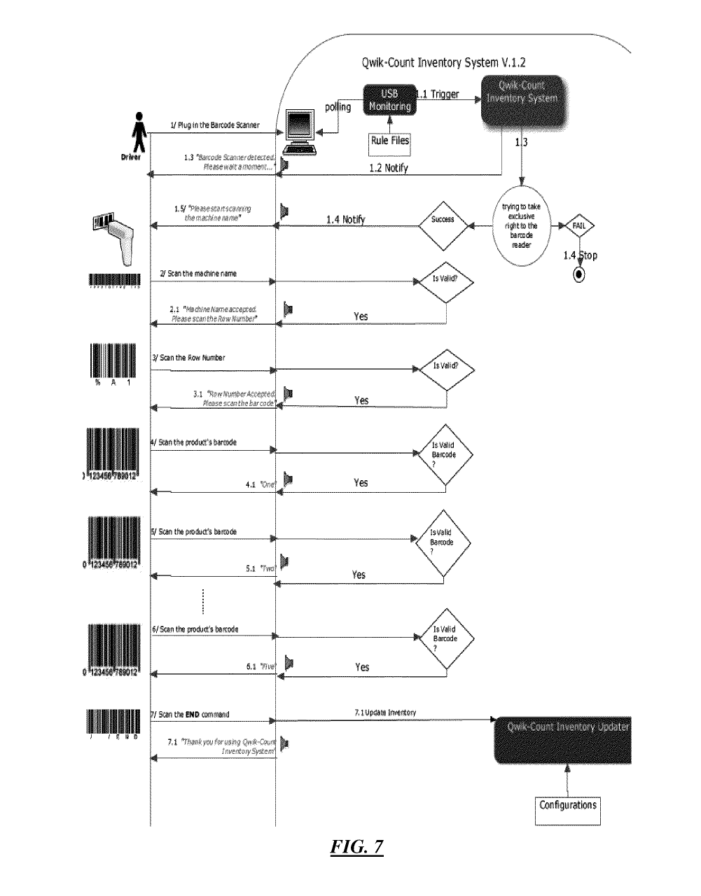

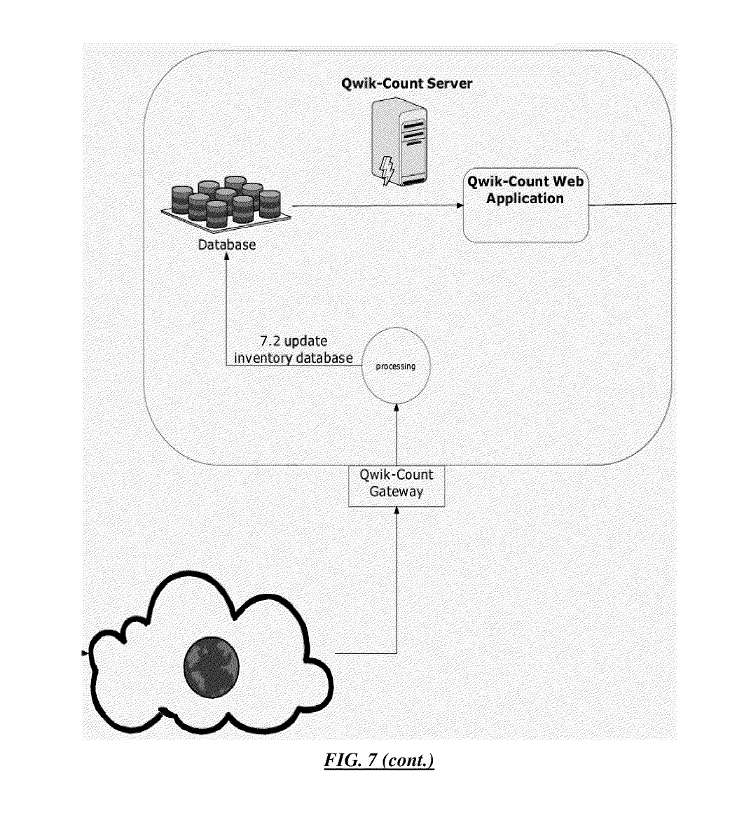

Thus, in specific embodiments, the invention addresses the need for vending operators to know when there are only five items left to sell, so an alert will be sent out. To do this, the invention captures from the vending stocking person how many and what is put in each row of each machine. When the machine is stocked the operator scans a barcode at the top of the machine that identifies it. Then the first row to be stocked is scanned with its own specific bar code; example the letters A1 below a row in a vending snack machine would have a simple peel and stick bar code label identifying row A1. Then the operator would scan one item that is put in row A1. The software would know that this row holds 20 items, 10 were sold, and therefore 10 should be stocked. The operator proceeds to scan A2's bar code. Then scan the product of the bar code of the item placed in row A2 This is done successively for each row of each machine as it is stocked. This real-time information is available 24/7 and alerts may be are sent 24/7. As an example, FIG. 7 is a diagram (on 3 sheets) showing work flow chart illustrating inventory services according to specific embodiments of the present invention.

In specific embodiments, one thin-client as described herein can be connected to many cameras, with cameras deployed in several different dispensing machines.

In further embodiments, vending operator clients may organize their warehouses like a vending machine; that is all the Mars Bars, for example, are in one place with a warehouse bar code on the storage bin or other appropriate place. When deliveries come in the inventory is scanned once per location and once per case, and/or once per box and/or once per item.

In particular implementations, the invention can be used as an independent third-party verification system by large manufacturers, schools, government agencies or anyone who needs independent sales information, usually to confirm commissions paid, identify products sold, data forecasting and economic modeling. Raw data feeds will be available on a subscription basis to a limited number of clients.

In further embodiments, a thin-client of the invention can be understood as a generally independent information device (such as a laptop, notebook, mini-desktop, mini-notebook, etc.) that generally is placed within the housing of an item dispensing or vending machine to provide one or more data collection and logic processing functions that are generally independent of the vending machine internals and thus can be installed on many different types of vending machines with no need for a substantial digital data interface between existing vending machines and the components of the invention.

In particular implementations, such an information device can provide a variety of services that are independent to or supplemental to the operation of the vending machine, such as area surveillance, wireless network services (e.g., provision of a hot spot), customer identification or surveillance, etc.

Furthermore, such an information device can use one or more existing, simple, data exchanges with a vending machine logic controller, for example using MDB as described above, for the purposes of more easily allowing payment processing (for example, using credit cards) or other data functions, for example, confirming a vend.

### Other Embodiments

Several features of a system as described above enable novel methods for managing multiple vending or dispensing machines from different manufactures and for different clients.

Because the collection of dispensing data is done largely independently of the particular electronics of a particular vending machine, the invention provides a way to install a small or large scale inventory control system with existing vending machines and with vending machines optionally remaining in-place and optionally not taken out of service for more than a short time.

Also, because the electronics of the system are largely independently of the particular electronics of a particular vending machine, the invention provides a way for an inventory service provider to easily deploy inventory systems according to the invention on a non-sales basis. A service provider may either lease systems to owners of vending machines or may provide a monthly inventory service to owners of vending machines and retain entire ownership for installed inventory equipment.

Furthermore, because the electronics of the system are largely independently of the particular electronics of a particular vending machine, the invention provides a way for an inventory service provider to use the same information infrastructure (e.g., the central server and the formatting and operation of the thin clients) to simultaneously provide inventory services to many different groups or owners of vending machines, while providing each group or owner of a vending machine secure access to its own inventory data.

Furthermore, with centralized collection of vending information from many different vending machine owners or groups, the invention allows easy collection of aggregated marketing statistics that can be provided as a separate product or service from the inventory services described herein.

### Emulated Compound Eye for the Purpose of Motion Detection

According to further specific embodiments of the invention, one or more aspects of an improved motion detection processing system as describe below may be used for collecting inventory data from a vending machine. Conventional motion detection performed with a digital capture device (e.g., a visible light or infra-red camera) connected to a logic processor (e.g., a general purpose or special computer device) is often highly limited. Generally, motion is not detected so much as change in a captured digital image or captured digital video is detected. Logic instructions and/or software in existing systems either looks for a percentage change in pixels from one frame to the next or it looks for a percentage change from one frame to the next within a specific area of the field of view, which may be referred to as a “zone.” This method of motion detection is generally directed to situations where it is not known in which areas and/or in which direction an object is likely to be moving. Many current visual motion detection systems are intended mostly for basic security systems, where the source of movement is unknown.

Many systems have attempted to improve on motion detection, for example, U.S. Pat. No. 7,356,439, MOTION DETECTION APPARATUS AND METHOD. issued Apr. 8, 2008, foreign priority claimed Nov. 27, 2002 [KR]. A number of these systems are directed to motion detection for the purposes of improving video image quality.

Various video surveillance strategies are also discussed in the following and in their cited or incorporated references:

| | | | |
|---|---|---|---|
| 6271752 | Intelligent multi-access system | August, 2001 | Vaios |
| 6456321 | Surveillance camera apparatus, remote surveillance | September, | Ito et al. |
| | apparatus and remote surveillance system having the | 2002 | |
| | surveillance camera apparatus and the remote surveillance | | |
| | apparatus | | |
| 6504479 | Integrated security system | January, | Lemons |
| | | 2003 | et al. |
| 6512537 | Motion detecting apparatus, motion detecting method, and | January, | Shimizu |
| | storage medium storing motion detecting program for | 2003 | et al. |
| | avoiding incorrect detection | | |
| 6583813 | System and method for capturing and searching image | June, 2003 | Enright et |
| | data associated with transactions | | al. |
| 6856343 | Digital video logging system | February, | Arazi et |
| | | 2005 | al. |
| 6867799 | Method and apparatus for object surveillance with a | March, 2005 | Broemmelsiek |
| | movable camera | | |
| 6912429 | Home automation system and method | June, 2005 | Bilger |
| 6961082 | Image display control system reducing image | November, | Miura et |
| | transmission delay | 2005 | al. |
| 7075567 | Method and apparatus for controlling a plurality of image | July, 2006 | Hunter et |
| | capture devices in a surveillance system | | al. |
| 7106333 | Surveillance system | September, | Milinusic |
| | | 2006 | |
| 7124427 | Method and apparatus for surveillance using an image | October, | Esbensen |
| | server | 2006 | |
| 7136106 | Apparatus controller, device and method for controlling | November, | Shinohara |
| | data transmission of digital apparatus, and data | 2006 | et al. |
| | transmission control system | | |
| 7231654 | Remote monitoring method and monitor control server | June, 2007 | Murai |
| 20020163577 | Event detection in a video recording system | November, | Myers |
| | | 2002 | |
| 7421727 | Motion detecting system, motion detecting method, | Nov. | Oya |
| | motion detecting apparatus, and program for | 02, 2008 | |
| | implementing the method | | |

| | | |
|---|---|---|
| JP10040185 | February, 1998 | SERVER AND TERMINAL AND METHOD FOR |
| | | CONTROLLING THE SAME |
| JP11041589 | February, 1999 | METHOD AND SYSTEM FOR SUPERVISING |
| | | MOBILE OBJECT |
| JP2003259341 | September, 2003 | IMAGE DISTRIBUTION SYSTEM, |
| | | COMMUNICATION APPARATUS, DISTRIBUTION |
| | | APPARATUS, CONTROL METHOD FOR THEM, AND |
| | | STORAGE MEDIUM |
| JP2003259360 | September, 2003 | IMAGE CHANGE DETECTION SYSTEM AND |
| | | CONTROL METHOD THEREOF, IMAGE CHANGE |
| | | DETECTION APPARATUS, COMMUNICATION |
| | | APPARATUS, IMAGE CHANGE DETECTION |
| | | METHOD, COMMUNICATION METHOD, AND |
| | | STORAGE MEDIUM |

According to specific embodiments, motion detection of the present invention achieves superior results in many motion detection situations where it is generally known in which areas and/or in which directions motion of interest is to take place.

In situations where it is known where and/or in which direction the movement will occur, the present invention provides a high level of reliability both in detecting movement and also avoiding false positives (for example, those that can occur due to ambient light, dust floating near a camera lens, video interference or line noise).

In specific embodiments, the invention may be understood as involving directed zone motion detection (DZMD)—though the current standard in performing “zone” detection is little more than the conventional method of motion detection (e.g., percentage pixel change) aimed at one portion of the field of view.

Thus according to specific embodiments of the invention, the invention performs motion detection by analyzing multiple tiny zones that have much higher trigger thresholds than the single zone they replace.

Using a conventional zone there is typically a large amount of white space or background that comprises the total amount of pixels within the zone, this means that the zone must trigger with a very small amount of change to counteract the static nature of the background. The present invention improves upon this system by using multiple tiny zones within the same area of the aforementioned zone. Some of these smaller zones will see only white space and will not trigger when the object is moved—but some will cover key areas of the object and will register a large change when the object moves. Thus, a much higher threshold for these tiny zones can be used than one large zone because the areas that register change will register a lot of it because by chance they are on a key area of change upon object motion. The increase in threshold allows the invention according to specific embodiments to avoid false positives that come along with low thresholds that can be accidentally set off by a variety of non-object related movement.

Tiny zones according to specific embodiments of the invention can be automatically populated within a user specified area. In further embodiments, an end user can adjust a movement detection trigger not by a percentage change in pixels but by a cut-off number of triggered sub-zones.

In further embodiments, the invention can also use the detected direction of motion to improve detection and eliminate false positives. For example, when detecting motion of items that can only drop due to gravity (e.g., in an automated dispensing or vending machine), if three vertically adjacent tiny zones are triggered from top to bottom in order, it can be determined that the object has dropped. If the tiny zones have been triggered from bottom to top, generally some form of interference is present like a particle of dust floating upwards or vandalism.

In addition to the user selected zones that become automatically populated with tiny zones, a system according to specific embodiments of the invention can automatically populate an entire field of view with tiny zones. In such an embodiment, logic according to specific embodiments of the invention has indications of what objects in a field of view are moving. (For example, in a vending machine, a software system may have access to digital information from the machine, such as which selection buttons are pressed or which dispenser is activated. A human operator could also input which dispenser (e.g., row and column) is activated. Software according to specific embodiments of the invention will note which tiny zones in the matrix are set off upon movement from the specified area—the software would note both how many tiny zones are triggered as well as the direction in which they are triggered.

Thus, in a specific example embodiment, consider a relative inexpensive digital capture device with a relative small capture pixels of 640×480 pixels. Using such a capture device to image a vending machine, for example, each vended object (such as a candy bar) might image onto an area of about 20 pixels×50 pixels. To capture an appropriate field of view, generally very specific lenses and camera assembly is done.

A typical prior art zone motion detector might define a zone as about the size of the vended object (e.g., 20 pixels×50 pixels) or a larger size to encompass the object and surrounding areas. A change in some percentage of pixels is subsequent frames of this larger zone in a prior art system may be detected as motion.

According to specific embodiments of the invention, however, using the example above, a directed zone motion detection (DZMD) zone will be relative small, (e.g., 5×5 pixels, 4×4 pixels, 6×2 pixels, etc.) In various embodiments, a directed zone motion detection (DZMD) zone will be at least 2×2 pixels and generally no larger than about 25% of the area of the object that is expected to move.

In specific embodiments, motion is registered when there is a threshold percentage change, (such as 20%) in at least a cut-off number of zones (e.g., 2, 3, 4 or more) and furthermore, according to specific embodiments of the invention, in a particular direction (e.g., such as down or in a direction of traffic flow). Various corrections to account for overall change is ambient light or overall motion can be employed, as will be understood in the art.

### Example Driver Work-Flow Embodiment

FIG. 7 is a diagram (on 3 sheets) showing work flow chart illustrating inventory services according to specific embodiments of the present invention. This detailed implementation diagram is provided as an example only. On the first sheet is shown a driver procedure for scanning items at a vending machine using an example USB connected hand-held bar-code scanner. A client module (such as discussed above, shown in the figure as a diagram of a personal computer) monitors the USB connection and when a scanner is detected directs the driver to scan information about the vending machine, row, and items placed in the vending machine. The client module communicates over the Internet to a gateway as shown in sheet 2. Inventory data is stored in a database and a server makes one or more web interfaces available to users of the system, as illustrated in sheet 3.

### Embodiment in a Programmed Information Appliance

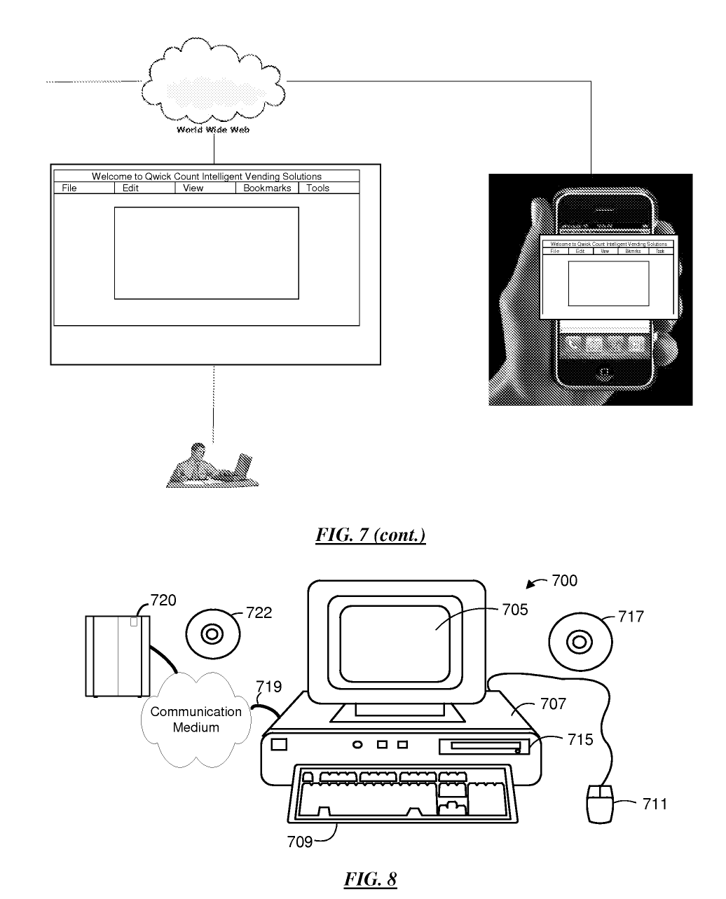

FIG. 8 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a user's computer or a fixed media containing logic instructions may reside on a remote server that a user accesses through a communication medium in order to download a program component. According to specific embodiments, access with the vending machine modules is all performed using a standard HTML compatible browser.

FIG. 8 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. This system can also be configured as shown in FIG. 3, with the CPU being inside module 310 and the display being a graphical interface made available over a network as would be understood in the art or the display 322. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD) or a custom client module as described herein. In such a case, the invention may be embodied in a computer understandable descriptor language, which may be used to create an ASIC, or PLD that operates as herein described.

### Other Embodiments

The invention has now been described with reference to specific embodiments. Other embodiments will be apparent to those of skill in the art. In particular, a user digital information appliance has generally been illustrated as a personal computer. However, the digital computing device is meant to be any information appliance for interacting with a remote data application, and could include such devices as a digitally enabled television, cell phone, personal digital assistant, laboratory or manufacturing equipment, etc. It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein or filed with this application, including any references filed as part of an Information Disclosure Statement, are incorporated by reference in their entirety.

1. A method of providing data and/or video services at vending machines comprising:
installing information processing modules at one or more of said vending machines, said information processing modules being substantially logically independent of said vending machines;
said information processing modules providing at least one data acquisition or data transmission service that is substantially independent of any data processing performed by said vending machines;
wherein one or more of said independent information processors may be used to provide aggregated and/or coordinated data services for a plurality of vending machines;
wherein said plurality of vending machines are from a variety of manufacturers with a variety of different native logic processing functions and/or protocols.

2. The method according to claim 1 further wherein said at least one data acquisition or data transmission service is one or more selected from the group consisting of:
collecting vicinity surveillance data from one or more image or video or motion detection capture devices;
collecting surveillance data of dispensed items from one or more image or video capture devices;
collecting customer surveillance and/or marketing data from one or more image or video or motion detection capture devices;
providing wireless internet services in a vicinity of said vending machines;
transmitting data regarding said vending machines to one or more remote locations over a local or wide area communications network;
collecting and/or verifying payment information from a user of said vending machines;
collecting and/or verifying stocking information from a services of said vending machines; and
collecting and/or verifying cash on hand information from a services of said vending machines.

3. The method according to claim 1 further comprising:
installing said independent information processor substantially inside of a secured housing of at least one of said vending machines.

4. (canceled)

5. The method according to claim 1 further comprising:
said independent information processing module interfacing with a simple logical connector to a native controller of said vending machines to provide limited control functions such as triggering a vend after a credit card validation operation performed by said processor.
said independent information processing module using a defined protocol such as MDB to interface with a simple logical connector to a native controller of said vending machines.
said independent information processing module using a defined protocol such as MDB to interface with a simple logical connector to a native controller of said vending machines to provide one or more of:
access to payment processing services that are substantially provided by said independent information processor;
verifying vending data independently collected by said independent information processor.

6-7. (canceled)

8. The method according to claim 1 further comprising:
deploying thin clients inside and outside of new and legacy vending machines to provide third party accounting data for sales taxes and/or commission payments;
wherein said data can also be directly imported into many commonly used business applications for accounting and inventory control and reordering.

9. The method according to claim 1 further comprising one or more of:
providing nutritional information for one or more items on a touch screen, wherein a user indicates a selection and then the nutritional information is displayed on the touch screen;
providing information about one or more price changes or price promotions on said touch screen.
a data connection between said vending machine and said thin client to allow direct dispensing of a product as a result of a credit card or other thin client authorized sale.
video confirmation of machine security and buying behaviors of the vending machine's specific customers.

10-12. (canceled)

13. The method according to claim 1 further comprising:
wherein said vending machines are automated dispensers;
installing a plurality of after-market independent logic systems at a plurality of said automated dispensers;
said logic systems configured to perform one or more of the following:
capture surveillance data in a vicinity of an automated dispenser;
process payments for an automated dispenser;
observe dispensing of items by said automated dispensers with at least a portion of said observed data independent of any significant digital data interface between said automated dispensers and said data collection systems;
at said plurality of data collection systems, preprocessing captured data to determine initial dispensing data;
transmitting said initial dispensing data to an inventory server computer system for additional analyzing and for aggregating data from multiple data collection systems;
providing inventory data to one or more owners or managers of multiple automated dispensers on a regular basis as a subscription service.

14. A system for aggregating inventory control information from a plurality of vending machines comprising:
a plurality of vending machine information processing client modules, wherein a plurality of said client modules are installed within housings of a plurality of vending machines;
said client modules comprising:
a communication interface for communication with a server over a communication network;
a sales and inventory video interface for receiving image data indicating the status of inventory and/or sales;
an interface for exchanging information related to inventory with a vending machine stocker;
said server collecting and aggregating data regarding said plurality of vending machines received from said plurality of clients.

15. The system according to claim 14 further comprising:
an input interface for receiving customer selection and/or payment information; and
a limited interface to said vending machine to confirm payment and direct vending of an item.

16. The system according to claim 14 further wherein said vending machines have two or more different and incompatible native control systems.

17-19. (canceled)

20. The system according to claim 14 wherein a plurality of said vending machine information processing modules further comprise one or more of:
a presentation device operationally connected and controlled by said modules;
a customer image capture device operationally connected and controlled by said modules;
said presentation device comprises a touch-screen display device for accepting customer selection inputs and displaying data to a customer;
vicinity surveillance capture devices, such as image or video or motion detection capture devices;
dispensed items image capture devices;
wireless interne provision device;
payment processing device;
stocking information input device; and
cash on hand verification device.

21. The system according to claim 14 wherein a plurality of said vending machine information processing modules further comprise:
a simple data interface to a vending machine allowing indication of a vend operation upon payment confirmation;
data collection to provide third party accounting data for sales taxes and/or commission payments;
wherein said server system provides data in a form that can be directly imported into many commonly used business applications for accounting and inventory control and reordering;
a data interface to one or more data sources providing nutritional information for one or more items in said vending machine;
wherein when a user indicates a selection, nutritional information may be displayed on the touch screen;
a data interface to one or more data sources providing pricing or promotional information for one or more items; and
further wherein said modules provide at least one data acquisition or data transmission service that is substantially independent of any data processing performed by said vending machines.

22-29. (canceled)

30. The system according to claim 14 further wherein:
said client modules comprise a plurality of logically compatible systems that can be configured to observe dispensing of items by a wide variety of different automated dispensers without the need for a data interface between said data collection systems and said automated dispensers;
said client modules comprise a plurality of logically compatible systems that can be easily installed to a wide variety of different existing automated dispensers.
said client modules comprise one or more imaging devices that can be mounted near, or on, or inside a vending machine, wherein said imaging devices comprise one or more digital cameras that detect visible and/or infrared and/or ultraviolet light.
said client modules comprise: one or more local logic processors; a digital memory; a communications interface for transmitting various locally collected information to a server.
said client modules comprise: one or more cameras; a local communications interface for transmitting data with nearby data devices.

31-44. (canceled)

45. The method according to claim 1, further for providing an inventory control service to owners or managers of multiple automated dispensers of items and further comprising:
installing a plurality of after-market data collection systems at a plurality of said automated dispensers;
said data collection systems configured to observe dispensing of items by said automated dispensers, at least a portion of said captured data independent of any significant digital data interface between said automated dispensers and said data collection systems;
at said plurality of data collection systems, preprocessing captured data to determine initial dispensing data;
transmitting said initial dispensing data to an inventory server computer system for additional analyzing and for aggregating data from multiple data collection systems;
providing inventory data to one or more owners or managers of multiple automated dispensers on a regular basis as a subscription service; and
further wherein said data collection systems comprise a plurality of logically compatible systems that remain the property of a central inventory data provider.

46-51. (canceled)

52. The method according to claim 45 further comprising:
aggregating data from many different automatic dispensers made by many different manufacturers into one or more inventory and management groups;
gathering sales and inventory data on a individual automatic dispenser (e.g., a vending machine) by the use of a visible light or infrared camera;
transmitting gathered data to a server system;
processing data at said server system;
transmitting reports that contains data of interest, such as sales (money) and/or necessary restocking inventory by machine and by route.

53. (canceled)

54. The method according to claim 45 further comprising:
capturing a digital image of a person to whom an item is dispensed;
associating said digital image with other data regarding a dispensing transaction, such as (1) methods of payment; (2) identify of item dispensed; (3) date, time and location; (4) inventory regarding other items available at said dispenser.

55-61. (canceled)

62. A method of automatic motion detection using a logic processing system comprising:
capturing a digital video pixel sequence;
analyzing pixels of said video pixel sequence by dividing said video pixel sequence into many small areas (or zones) and analyzing pixels in each area together;
setting a high trigger threshold for detecting an image change for each zone;
setting a cut-off number of zones for detecting motion;
registering motion when a cut-off number of zones have each exceeded said high trigger threshold; and
transmitting data indicating motion has been detected to a user or other logic processing system.

63. The method of claim 62 further comprising one or more of:
registering motion when said cut-off number of zones have each exceeded said high trigger threshold in one or more indicated expected directions;
rejecting as a false positive a motion detection when said cut-off number of zones that have each exceeded said high trigger threshold occur in one or more designated false positive directions.
detecting motion of one or more objects by setting said areas (or zones) to be approximately 25% of the imaged area of said one or more objects;
setting a cut-off number of zones for detecting motion of one or more of said objects;
registering motion of one or more objects when a cut-off number of zones have each exceeded said high trigger threshold; and
transmitting data indicating motion of one or more of said objects has been detected to a user or other logic processing system;
wherein said digital video pixel sequence captures a sequence of about 640×480 pixels and said objects image onto an area of about 20 pixels×50 pixels and said small areas (or zones) are e.g., 5×5 pixels, 4×4 pixels, 6×2 pixels, and generally at least 2×2 pixels;
wherein said digital video pixel sequence captures a sequence up to about 10,000×10,000 pixels and said objects image onto an area of up to about 200 pixels×200 pixels and said small areas (or zones) are up to about 100 pixels×100 pixels;
wherein said threshold percentage change is about 20% and said cut-off number of zones is greater than 1.
defining zones such that at least two zones will be substantially imaged by an object and will register a large change when said object moves.
providing a data input allowing a user to adjust a trigger not by a percentage change in pixels but by a number of triggered sub-zones used as a cut-off.
using said logic processor to automatically determine and define tiny zones by analyzing captured image data;
providing a data input allowing a user to select zones.
automatically populating a field of view with tiny zones by reading indications of what objects in a field of view are moving, detecting which zones are triggered upon movement from the specified area, detecting both how many zones are triggered as well as the direction in which they are triggered, and storing results of said detecting for future motion detection;
wherein said objects are items in an automated dispenser and said automatic motion detection determines that an object has been dispense and the location from which the object has been dispensed;
wherein said objects are items in an automated dispenser and said automatic motion detection determines that an object has been dispense and the location from which the object has been dispensed without substantial logic data connection between said logic processing system and said automated dispenser;
wherein said objects are vehicles moving on a defined path and said automatic motion detection determines a number of vehicles that have moved through a field of view;
wherein said objects are items being moved on an automated conveying system and said automatic motion detection determines a number of items moved through a field of view; and
wherein said objects are manufactured products moving on a defined path and said automatic motion detection determines a number of manufactured products that have moved through a field of view.

64-79. (canceled)

80. A computer readable medium containing computer interpretable instructions that when loaded into an appropriately configured information processing device will cause the device to operate in accordance with the method of any claim 1.

81-93. (canceled)
